(19) United States
(12) Patent Application Publication
(10) Pub. No.: US 2021/0344719 A1
(43) Pub. Date: Nov. 4, 2021

(54) SECURE INVOCATION OF NETWORK SECURITY ENTITIES

(71) Applicant: CSP, INC., Lowell, MA (US)

(72) Inventors: Timothy F. OBER, Atkinson, NH (US); Gary S. SOUTHWELL, Chelmsford, MA (US)

(21) Appl. No.: 17/285,426

(22) PCT Filed: Nov. 7, 2018
(86) PCT No.: PCT/US2018/059556

§ 371 Date: Apr. 14, 2021

Related U.S. Application Data
(60) Provisional application No. 62/583,252, filed on Nov. 8, 2017.

(51) Int. Cl. H04L 29/06; G06F 8/61; H04L 9/30; G06F 9/455

(52) U.S. Cl. CPC H04L 63/20; G06F 9/45533; H04L 9/30; G06F 8/61

(57) ABSTRACT

A method of enforcing, deploying and invoking network security includes identifying a plurality of computing entities adapted for invocation on a network entity in an interconnected network, such that each network entity is adapted to launch and execute at least one network conversant app. An agent deploys the identified security entity on a target network entity or node, such that the security entity is responsive to the security agent previously deployed on the network entity. Upon deployment and launch, a security manager in communication with each of the security entities receives an indication of security entity operation. The security entity is thereafter enabled to scrutinize network traffic by evaluating the identified data upon ingress or egress to determine a security event, and to communicating with the security manager to provide consistent continued instantiation of the security entity.

### BACKGROUND

Computer network security has becoming an increasingly compelling concern for corporate and individual users alike. Media attention to data breaches of corporate repositories, and the resulting liability, has resulted in computer security, or so-called “cybersecurity,” to become a requirement of sound business practices. In a highly connected enterprise, having multiple sites and telecommuting employees, the reach of the corporate computing infrastructure can be substantial, however any weak point in this infrastructure potentially compromises the entire network.

### SUMMARY

A software defined security (SDS) solution provides a centralized approach to security deployment across an entire enterprise infrastructure. Modern virtualization approaches serve to separate the physical machine, or server, from the operating system and applications that run on it. Implementation of aspects such as virtual machines, hypervisors, and containers compartmentalize operating systems and running environments such that the physical machine no longer binds applications to an execution platform. A robust security approach implements a security container deployable on various computing entities, whether defined by a hypervisor, container or dedicated operating system. Protected application entities (apps) launch in an execution environment that may be virtualized, yet is protected by the container deployed on the computing entity on which it resides. The security containers identify, for each computing entity, available security resources, and apply these available resources to ingress and egress data of the computing entity. Each of the security containers is responsive to a security manager, which implements a network policy through the security containers. The network policy defines logic that, when implemented by the security container, scrutinizes the ingress and egress traffic for compliance, and disallows and/or reports deviant transmission attempts.

Conventional network security relies on an interconnection of network conversant computing devices. In order to maintain security of data passed between the computing devices, it is typical to employ some type of security measures on each computing device. Typically this is done at a network interface, such as an Ethernet network interface card (NIC) on each machine, or at a network ingress/egress point for a group of computing devices in close proximity such as a building, site or enterprise campus. Configurations herein are based, in part, on the observation that processes and apps entrusted with security tasks must themselves be assured of a secure load and startup.

Unfortunately, conventional approaches suffer from the shortcoming that it can be problematic to identify and cover all steps in deploying and instantiating a security entity in a network supporting an enterprise environment. Varying degrees of automation, combined with different platforms and security product availability for each computing device, can make it difficult to ensure an unbroken, trusted sequence of deployment.

Accordingly, configurations herein substantially overcome the above described shortcomings by securely deploying and instantiating a software defined security (SDS) instantiation across each computing entity across the network to which the policy applies. A security manager identifies the network entities, or nodes, for which security entities are called for. An agent provides a trusted execution environment on each node. A key exchange from a security manager or orchestrator ensures secure transfer of images, and the agent oversees key management and segregation of trusted and untrusted images and data prior to startup.

In further detail, the method of enforcing, deploying and invoking network security as disclosed herein includes identifying a plurality of computing entities adapted for invocation on a network entity in an interconnected network, such that each network entity is adapted to launch and execute at least one network conversant app. An orchestrator identifies a manner of execution of each of the computing entities, in which the manner of execution defines supporting resources employed in the execution. Based on the manner of execution, the orchestrator selects a security entity corresponding to each identified computing entity, such that the security entity is operable to identify data associated with the computing entity. An agent coupled to the orchestrator deploys the identified security entity on a target network entity or node, such that the security entity is responsive to the security agent previously deployed on the network entity. Upon deployment and launch, the security manager (orchestrator) in communication with each of the security entities receives an indication of security entity operation. The security entity is thereafter enabled to scrutinize network traffic by evaluating the identified data upon ingress or egress to determine a security event, and to communicate with the security manager to provide consistent continued instantiation of the security entity.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a prior art computing environment;

FIG. 2 shows a general model of software defined security as disclosed herein;

FIG. 3 shows a block diagram of a network arrangement based on the model of FIG. 2;

FIG. 4 shows an enterprise deployment of an interconnected environment using the model of FIG. 2;

FIG. 5 shows the structure of a security agent in the environment of FIG. 4;

FIG. 6 shows deployment of the agent of FIG. 5 in conjunction with the security entities and security manager in the environment of FIG. 4; and

FIG. 7 shows a secure load for deploying the security entity of FIG. 6 on a network entity from which the agent is launched.

### DETAILED DESCRIPTION

Configurations depicted below present example embodiments of the disclosed approach in the form of an infrastructure which discovers the infrastructure network, deploys security containers via a secured transfer and launch, and continually monitors the security containers for response and effectiveness. In the network infrastructure, including computing entities adapted for running applications and network entities adapted for transporting data between the computing entities, security containers implement a method for protecting data. The network entities transport data in ingress to or egress from the computing entities, such as network interfaces cards (NIC) in the individual servers, routers, switches, and other devices primarily for data transport rather than computation.

A security manager, or orchestrator, identifies a plurality of computing entities, such that each computing entity is operable for launch and execution of application entities on a particular platform. Each platform includes a server device and computing entities residing on the server device. Each computing entity includes at least one operating system and a capability to launch and execute at least one application entity. The platforms include hypervisors, containers and dedicated operating systems. Thus, a computing entity could be a dedicated machine with a single OS (Operating system), libraries/supporting files and application processes, or it could be a virtual machine or container sharing the same hardware.

Each server device includes at least one physical processor, and memory coupled to the physical processor, such that the memory is responsive to application entities for execution thereon. The computing entities occupy physical memory in the corresponding server device. Each of the physical servers (server devices) interconnects to other servers via physical connections at some level, however virtualization of the machine (hypervisor) and of the operating system (container) blurs the distinction between computing and network entities.

Discovery includes identifying a set of network entities interconnecting the computing entities, such that the network entities and the platforms define the network infrastructure. The security manager determines, for each of the computing entities, a manner of execution based on the platform, the server device and interconnected network entities. The security manager then determines, based on the manner of execution of each of the computing entities, a security entity. Depending on the available resources, the determined security entity provides a best available security level for each computing entity. Some computing entities are virtual machines, of which several exist on a single server. The security manager instantiates, on the server device of each platform, a security container for scrutinizing ingress and egress data for each of the computing entities on the platform. In this manner, the entire infrastructure is protected by the best available security according to the network policy by deployment of the security containers.

Each deployed security container is operable to receive a security policy indicative of security logic for permitting data transport to and from the computing entity, and for identifying data flow to and from the computing entity. The security container applies the security logic to the identified data flow, and renders an event and remedial action based on the results of applying the security logic.

The disclosed approach takes note of the reality that each execution entity on which apps reside may not be a conventional dedicated OS and server. Rather, virtualization may separate the OS, machine and supporting libraries through the use of virtual machines and containers. The application entities launch in various manners of execution, such as through a hypervisor (VM), container (same OS, compartmentalized libraries) or a dedicated server (conventional OS and shared memory). The manner of execution is recognized by the security manager in deploying the security container. Therefore, the method of enforcing network security as disclosed herein includes identifying a plurality of computing entities, such that each network entity is adapted to launch and execute a network conversant app, and identifying a manner of execution of each of the computing entities, in which the manner of execution defines supporting resources employed in the execution (e.g. libraries, support files and OS).

The security manager identifies, based on the manner of execution, a security entity (security container) corresponding to each identified computing entity, such that the security entity is operable to identify data associated with the computing entity. The security manager includes logic for enforcing the network security policy. The security manager is in communication with each of the security entities, and receives an indication of security entity operation. Each security entity evaluates the identified data upon ingress or egress to determine a security event, and communicating with the security manager to provide consistent continued instantiation of the security entity.

As indicated above, the security entity is generally deployed based on best available security measures for the manner of execution. Depending on configuration, the security entity may be a container, or may be a hardware security module such as a security intelligent adapter, which replaces a conventional NIC in the server.

A container image, as used for the security container, is a lightweight, stand-alone, executable package of a piece of software that includes runtime support, i.e. code, runtime, system tools, system libraries, settings. Therefore, containerized software will always run the same, regardless of the environment. Containers isolate software from its surroundings, for example differences between development and staging environments and help reduce conflicts between teams running different software on the same infrastructure.

Containers and virtual machines have similar resource isolation and allocation benefits, but function differently because containers virtualize the operating system instead of hardware, containers are more portable and efficient. Containers are an abstraction at the app layer that packages code and dependencies together. Multiple containers can run on the same machine and share the OS kernel with other containers, each running as isolated processes in user space. Containers take up less space than VMs (container images are typically tens of MBs in size), and start almost instantly. Virtual machines (VMs) are an abstraction of the conventional hardware, effectively turning one server into many virtual servers (VMs). The hypervisor allows multiple VMs to run on a single machine. Each VM includes a full copy of an operating system, one or more apps, necessary binaries and libraries—taking up tens of GBs. VMs can also be slow to boot.

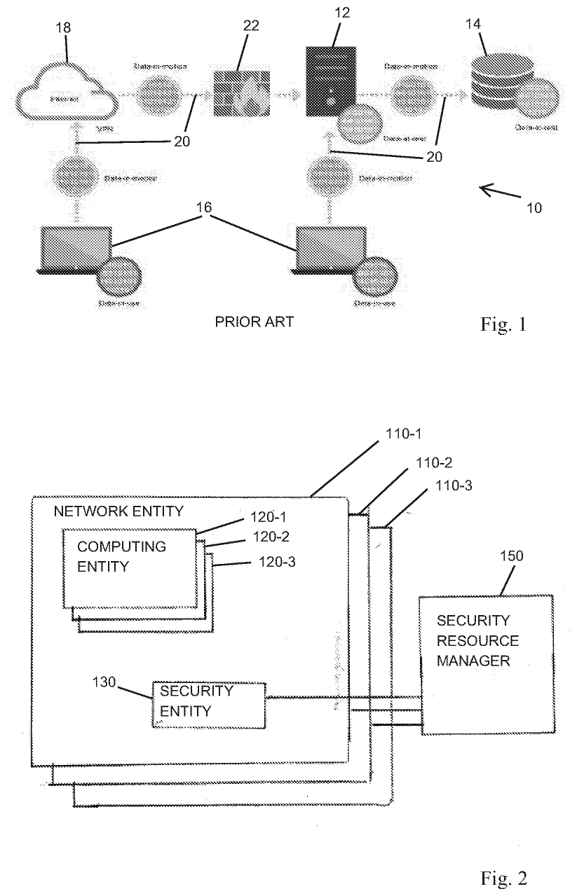

FIG. 1 is a context diagram of a prior art computing environment. Referring to FIG. 1, in a conventional network environment, network conversant computing devices, such as servers 12, storage devices 14, and user stations 16 interconnect via a public access network 18, such as the Internet and often referred to as “the cloud,” or dedicated local area networks (LAN)/wide area networks (WAN) and a series of links 20. The links convey data-in-motion between the network conversant devices, where it resides as data-at-rest in memory on a computing or storage device, or data-in-use as it is presented or input via a user input station 16 or device. Conventional security is provided by network interfaces upon ingress or egress from a computing device or network, using network interfaces, typically a network interface card (NIC), firewalls 22, and VPNs (Virtual Private Networks).

FIG. 2 shows a general model of software defined security as disclosed herein. Referring to FIGS. 1 and 2, an organization, business or other entity maintains a network infrastructure for providing computer services to users who invoke the infrastructure for computing services. Users may be interconnected at various locations, in various manners. Some may be remote, connected via VPN (virtual private network) access, and others may be collocated on a LAN at a particular site or building. Each employs a network entity 110-1 . . . 110-3 (110 generally), which are physical devices such as a server, desktop, laptop or other informational device. Network entities also include connectivity devices, such as routers, switches, and related devices. In general, each network entity 110 in the infrastructure connects directly or indirectly with other network entities via wired or wireless links.

Each network entity 110 may include one or more computing entities 120-1 . . . 120-3 (120 generally). Computing entities 120 include various partitions and arrangements of software entities, such as processes running under a common OS (operating system), virtual machines (VMs) operating in a hypervisor, and containers (independent entities sharing an OS). A computing entity is therefore capable of providing a user with impression of dedicated, interactive, computing services, even though the underlying network entity may support other computing entities.

In the infrastructure, uniform deployment and enforcement of the network policy is sought. Each network entity therefore has at least one security entity 130 for providing security to the computing entities relying on it. The security entity 130 may be a container, virtual machine or hardware structure coupled to the network entity for providing security. Each security entity 130 is in communication with a security resource manager 150 for ensuring common, consistent deployment of security entities for implementing the policy infrastructure wide. In a particular configuration, the security resource manager 150 may be fulfilled by an SDS orchestrator for instantiating software controlled entities that define or manage the security entity 130.

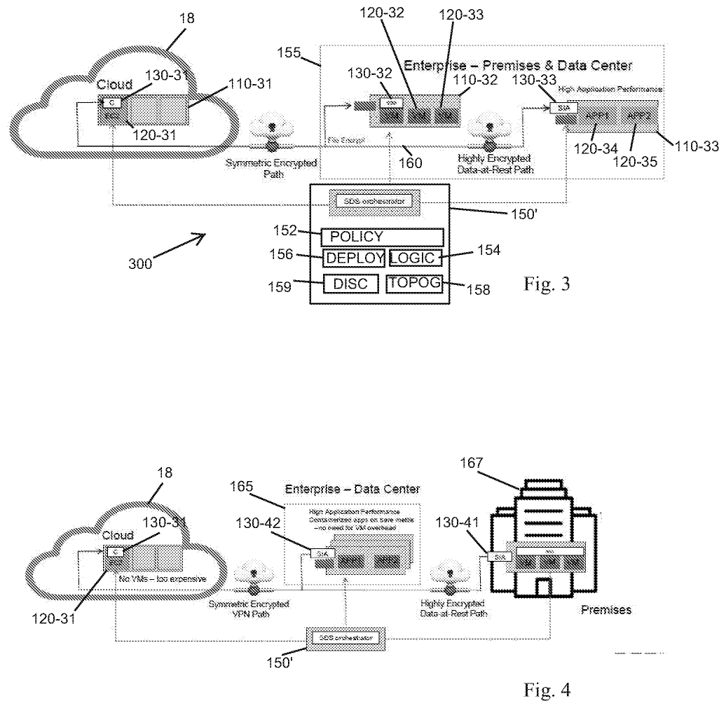

FIG. 3 shows a block diagram of a network arrangement based on the model of FIG. 2. Referring to FIGS. 2 and 3, the SDS orchestrator 150′ maintains the network security policy 152 including logic 154 for identifying and remedying security issues and events in the protected infrastructure 300. In FIG. 3, a remote network entity 110-31 couples to an infrastructure network 160 via the public access network 18. A local site 155 includes a local network entity 110-32 and a network entity 110-33 designated as a central server for high performance. The SDS orchestrator 150′ instantiates a security entity 130-31 defined by a container for a computing entity 120-31. The container is acceptable because the remote location likely does not have a huge demand, and the container will avoid the need for supporting libraries and files that may be at the local site 155.

At the local site 155, the network entity 110-32 in a hypervisor, and the SDS orchestrator deploys a security entity 130-32 defined by a virtual machine to cover the computing entities 120-32 and 120-33 (other virtual machines). The network entity 110-33 for high performance response, such as the data center or storage repository, employs a security entity 130-33 defined by a hardware interface card, or secure intelligent adaptor (SIA) which replaces the network card on the network entity 110-33. This provides higher performance to cover the computing entities 120-34, 120-35 at the data center.

FIG. 4 shows an enterprise deployment of an interconnected environment using the model of FIG. 2. Referring to FIGS. 2-4, an enterprise may be hosted by an off-site data center computing support facility, such as for software as a service (SaaS) implementation, as shown in FIG. 4. This is similar to FIG. 3, except that the primary data center 165 is off site from the main business facility 167. In this arrangement, the security entity for both the data center 165 and the business facility 167 is an SIA. Remote (cloud) users continue to operate using the container 130-31. The high computing intensity of the VMs at the business facility 167 is greater than the remote computing entity 120-31, thus the hardware performance of the SIA is called for by the business facility and the data center 165, but not necessarily for the remote user.

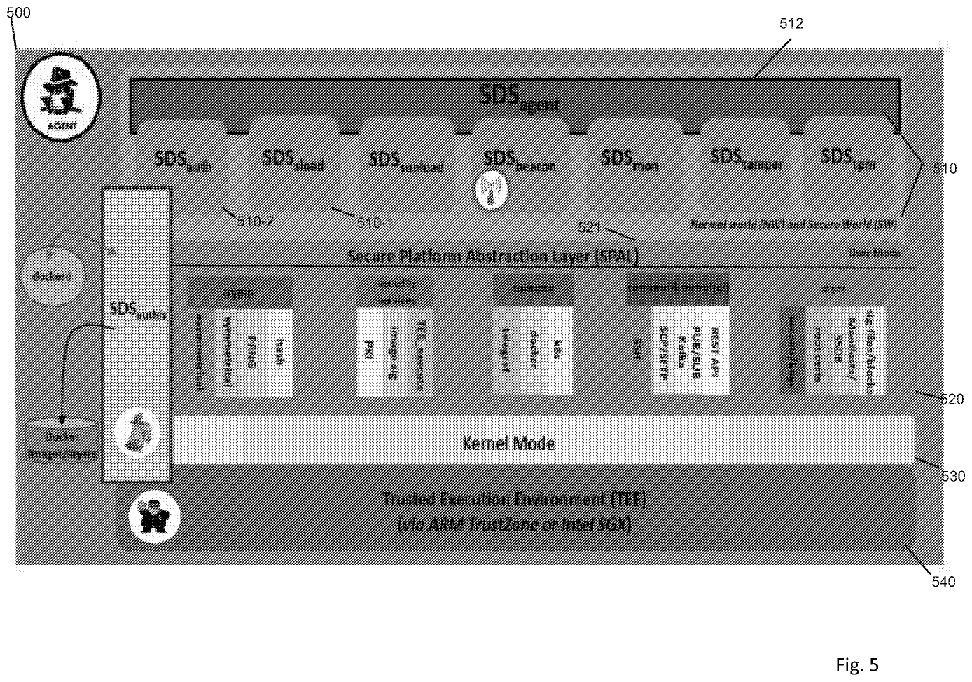

FIG. 5 shows the structure of a security agent in the environment of FIG. 4. Referring to FIGS. 4 and 5, a security agent 500 is structured as a layered model. This model provides security services 510 as directed from a controller 512. The agent 500 has 3 layers: user mode 520, including a secure platform abstraction layer 521, kernel mode 530, and a trusted execution environment (TEE) 540. While the user mode 510 encompasses the security services 510, the trusted layer 540 TEE layer provides a true hardware protected execution domain for protecting key material used by the various security services 510. In particular, the agent 500 services for load 510-1 and authenticate 510-2 are invoked to load and launch the security entities 130 without risk of compromise, discussed further below.

The intent of the agent 500 is to operate as a monolithic service provider with minimal dependencies, to facilitate deployment and startup. Preferable, it is operable as a boot-strap entity to facilitate scaling and machine/OS independence.

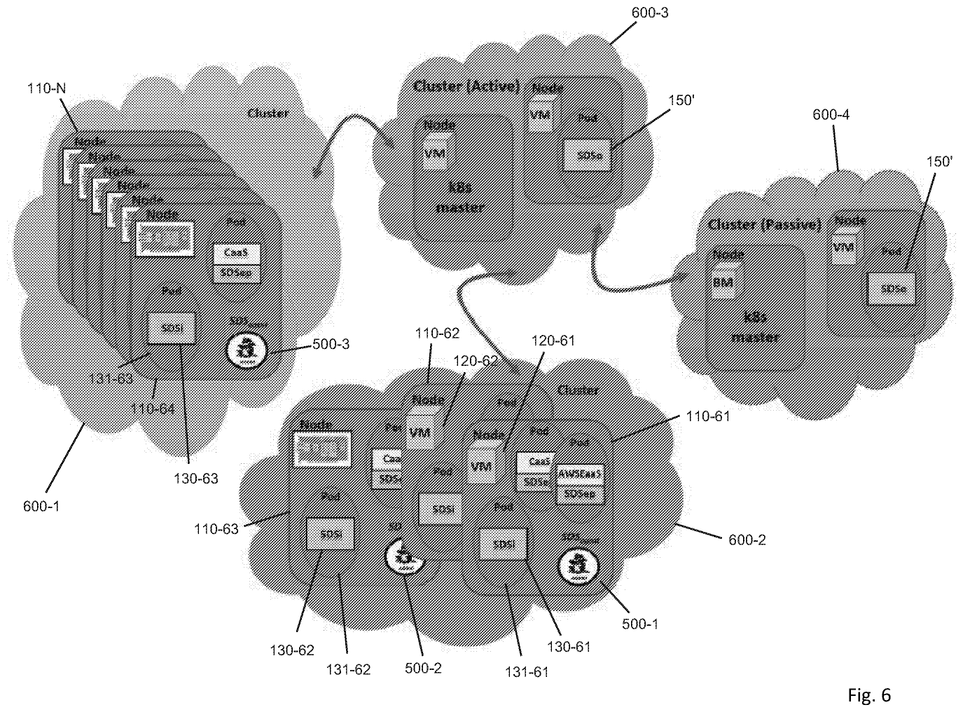

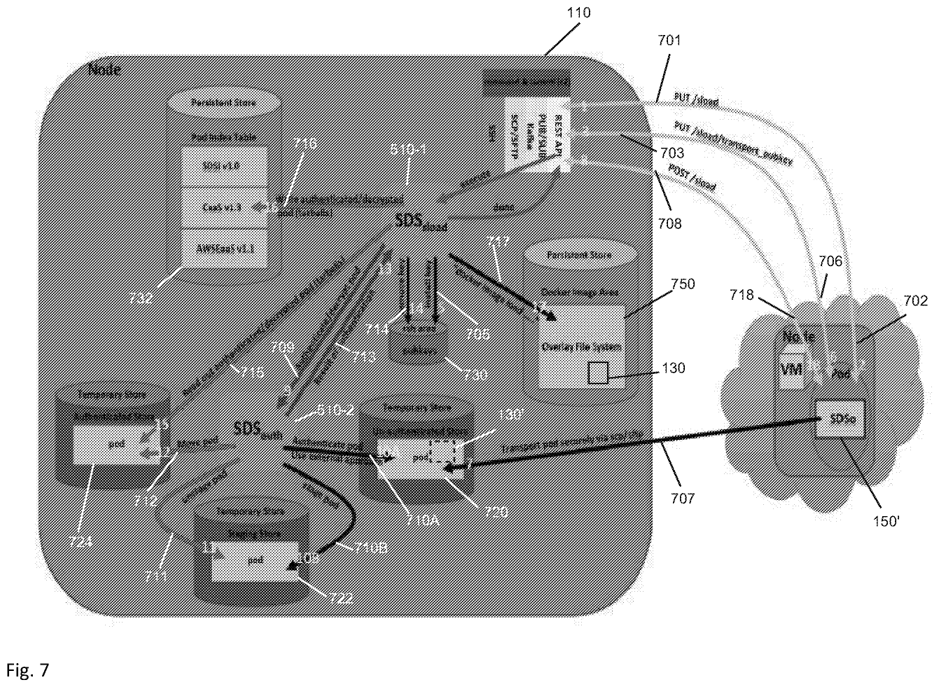

FIG. 6 shows deployment of the agent of FIG. 5 in conjunction with the security entities and security manager in the environment of FIG. 4. Referring to FIGS. 5 and 6, the agent 500-1 . . . 500-3 (500 generally) deploys on a network entity 110 prior to launch of security entities 130 to facilitate a secure launch of the security entities 130, discussed further below in FIG. 7. FIG. 6 shows an example infrastructure with a plurality of clusters 600-1, 600-2 responsive to a security manger 150 (orchestrator 150′) on remote clusters 600-3, 600-4. Each network entity 110 has an agent 500 and one or more security entities 130-61 . . . 130-63, deployed as one or more containers 131-61 . . . 131-63, or pods.

The different clusters 600 illustrate that each may be deployed, along with responsive nodes and pods, to disparate infrastructures, each having different security entities such as VMs, containers or hardware (SIA) implementations. Generally, however, it is expected that only one security entity 130 is needed per network entity 110 (hardware node or machine abstraction). Each agent 500, therefore, is associated with a network entity 110, or node, not to a specific security entity 130. It may be noted that an agent 500 is not needed at the orchestrator 150′ node as the orchestrator 150′ is a direct install rather than a deployment. In contrast, the agent 500 exists on every node requiring deployment of a security entity 130 to provide underlying security to the node for remote deployment.

Agent deployment, therefore, may occur several ways. As discussed above, above, an agent 500 is generally employed on all nodes running a pod 131 based security entity, and may be invoked by several mechanisms, for example the agent 500 may be invoked from SIA secure boot images. In this case the SIA is pre-installed with the agent 500 before the SIA is delivered to the customer, and is installed in a read only flash. Alternatively, the agent may be provided from predefined VMware or KVM (virtual machine) images. This involves creation of various VMs with the agent 500 pre-installed and personalized with the boot-strap key material to allow it to move to the internal security domain in a secure manner The agent 500 may also be deployed manually, if circumstances dictate. Thus, deploying the agent 500 ahead of the security entities 130 includes installing the security agent 500 via at least one of a pre-installed or read only flash and boot-strap key material for enabling secure communications with the security manager, and commencing the agent 500 based on an instruction from the security manager 150, in which the agent 500 has and provides a trusted execution environment 540 for the services 510 provided to the security entities 130.

FIG. 7 shows a secure load for deploying the security entity on a network entity 110 from which the agent 500 is launched. Referring to FIGS. 5-7, the load service 510-1 provides the container secure load services for the security entities. This involves a secure load of a security entity 130 into a persistent image store 750 of the node the pod is to run on. This service includes secure reception of the pod images using separate signed files/portions to reduce a large transfer failure rate. The agent 500 manages a separate image index table of pods in persistent store for expedited startup after shut-downs or crashes.

There are several mechanisms by which the load service 510-1 fulfills this task, insuring that the pod defining the security entity 130 is securely loaded into the persistent image store 750. The orchestrator 150′ is responsible for the deployment of container based (pods) security entities 130. In this deployment, a first phase of a handshake is issued by the orchestrator (orchestrator 150′) 150′ to determine if a version of the pod is loaded (or not) as well as to obtain a place to securely write it to and credentials/keys to do so, as shown by arrow 701. Information such as pod types, version, a JSON object, and whether or not to remove previous versions is included.

Deploying the security entity (pod/container) 130 on the network entity 110 having the commenced security agent 500 therefore includes performing a secure handshake with the security manager 150, determining if the security entity 130 has been previously loaded, and based on the determination, transmitting the security entity 130 to the network entity 110 based on a public key exchange with the security manager 150.

From here the load service 510-1 (function) will return to the orchestrator 150′ the data it requires for it to securely deploy the pod to the agent 500 or to authenticate and load. The items returned to the orchestrator 150′ are the SSD login (which the orchestrator will use when it generates the SSH key pair), the path to copy the pod image to, and the status of the pod/image in regards to preexistence.

The result object is received by the orchestrator on the line labeled 702. In response, the orchestrator generates the SSH key pair and then sends the public key portion to the load service 510-1 via the ‘PUT /sload/transport_pubkey’, shown by the line labeled 703, providing a JSON object with the SSH public key to use by the orchestrator 150′ to securely copy the pod to the agent 500, therefore no credentials (such as a password) need to be transmitted. The public key portion obviates the need for transmission of a password credential for authenticating or decrypting the security entity 130.

The load service 510-1 is triggered on the reception of the command, ‘PUT /sload/transport_pubkey’, command (703) and in response will install the public key portion into SSH service area, shown by label 705; this will allow the secure copy to succeed without credentials being used to securely transfer the pod/image of the security entity 130. The load service 510-1 will then return a OK as a response to the command and return a result JSON object that includes a unique UUID that the load service 510-1 assigns to the UnAuth store location and the installed public key. The key will be required as part of the ‘POST/sload’ command in order for the load service 510-1 to perform the copy and install of the pod/image and to clean up the public key when done, which allows for concurrent pod/image installs driven by unique IDs. The resulting JSON object is returned to the orchestrator 150′ via the line labeled 706.

Next, the orchestrator 150′ securely copies the pod/image of the security entity to the node 110 via the directory path received and the public key portion it generated and the account previously received earlier, as shown on line 707. The pod will be securely transfer encrypted using the public key portion generated by the orchestrator 150′ and provided to the load service 510-1. In particular arrangements, at least an RSA 2048b key will be used but likely will be larger. Each deployed pod/image will require a newly generated key pair to avoid reuse. Before the orchestrator 150′ copies the pod/image it will generate a new pod/image file and pre-pend the UUID it received (706) and the append the pod/image to it. This file is sent to an unauthenticated store (UnAuth) 720 (707). The unique UUID provides additional binding and liveliness to the install mechanism

The agent 500 has generated an index corresponding to an authenticated version of the security entity, and stored the generated index pending successful authentication of the security entity, as discussed with reference to lines 703-707 above. The agent 500 moves the security entity 130′ from an unauthenticated repository to an authenticated repository upon successful authentication, and deletes the generated index upon transferring an unencrypted version of the security entity to a launchable image area.

The orchestrator 150, therefore copies the security entity 130′ to a temporary store on the network entity, and receives a public key portion of a public key pair from the security manager. The agent 500 authenticates the copied security entity based on the received public key, and upon successful authentication, copies the authenticated security entity to a persistent image area on the network entity 110 for execution. Once the entire pod image 130′is securely copied to the unauthenticated store 130′ the orchestrator 150′ issues a ‘POST /sload’ command to the load service 510-1 via line 708 to tell the load service 510-1 to authenticate it and load it into the persistent store 750. This causes the load service 510-1 service to execute an authentication of the pod using the authentication service 510-2, shown by line 709. Responsively, the authentication service 510-2 authenticates the pod in the unauthenticated store 720, accomplished via line 10A. As the authentication service 510-2 reads the pod, to hash for the authentication of it (using DSA or similar authentication/hash), it also transfers at the same time to a temporary staging store 722, via the line labeled 10B. At the end of the authentication the SDS authentication service 510-2 will remove the pod from the “Un-authenticated Store” regardless of if the authentication passed or failed. The reason is to insure that once authenticated, it cannot be modified, such as by an adversary, as the path it now resides in the staging store 722 will be inaccessible. At this time it will also remove the UUID from its active list as well.

The authentication service 510-2 will unstage the pod in the staging store 722 to an authenticated store 724 only if the authentication passes, this is shown by lines 711 and 712. Regardless of whether the authentication was good or bad, the unstagging of the pod causes it to be removed from the staging store 722 by the SDS authentication service 510-2. Upon the completion, the SDS authentication service 510-2 returns back the authentication result to the load service 510-1 via line 713. It also provides it the location in the authenticated store 724 fur subsequent access. At this point it should no longer use the public key portion it got from the orchestrator 150′ so it deletes it from the key area 730 via line 714.

If the authentication passed, the load service 510-1 will then move the pod from the authenticated store to the pod index table 732 (PIT). The load service 510-1 will overwrite the index in the PIT 732 that contains the same pod type/name/version if it exists; this is accomplished via lines 715 and 716. After the PIT 732 has been updated the load service 510-1 will load the pod into the persistent image store 750, as shown by line 717. The load service 510-1 uses the pod's manifest that was authenticated in the pod to determine which container files in the authenticated pod/security entity 130 to load into the persistent image store 750. After loading, a result is returned to the orchestrator 150′ to indicate the status of the authentication, as shown by the line labeled 718.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method of enforcing network security, comprising:
identifying a plurality of computing entities adapted for invocation on a network entity in an interconnected network, each network entity adapted to launch and execute at least one network conversant app;
identifying a manner of execution of each of the computing entities, the manner of execution defining supporting resources employed in the execution;
identifying, based on the manner of execution, a security entity corresponding to each identified computing entity, the security entity operable to identify data associated with the computing entity;
deploying the identified security entity on a network entity, the security entity responsive to a security agent previously deployed on the network entity;
receiving, at a security manager in communication with each of the security entities, an indication of security entity operation; and
evaluating the identified data upon ingress or egress to determine a security event; and
communicating with the security manager to provide consistent continued instantiation of the security entity.

2. The method of claim 1 wherein deploying the security entity further comprises:
installing the security agent via at least one of a pre-installed, read only flash and boot-strap key material for enabling secure communications with the security manager; and
commencing the agent based on an instruction from the security manager, the agent having a trusted execution environment.

3. The method of claim 2 further comprising securely deploying the security entity on the network entity having the commenced security agent by:
performing a secure handshake with the security manager;
determining if the security entity has been previously loaded; and
based on the determination, transmitting the security entity to the network entity based on a public key exchange with the security manager.

4. The method of claim 3 further comprising:
copying the security entity to a temporary store on the network entity;
receiving a public key portion of a public key pair from the security manager;
authenticating the copied security entity based on a public key corresponding to the received public key pair; and
upon successful authentication, copying the authenticated security entity to a persistent image area on the network entity for execution.

5. The method of claim 4 further wherein the public key portion obviates the need for transmission of a password credential for authenticating or decrypting the security entity.

6. The method of claim 4 further comprising:
generating an index corresponding to an authenticated version of the security entity;
storing the generated index pending successful authentication of the security entity;
moving the security entity from an unauthenticated repository to an authenticated repository upon successful authentication; and
deleting the generated index upon transferring an unencrypted version of the security entity to a launchable image area.

7. The method of claim 1 wherein the manner of execution includes hypervisors, containers and dedicated operating systems.

8. The method of claim 2 wherein the security entity is a container.

9. A network device for secure deployment of security entities, comprising:
a network entity having an interface to a security manager for identifying a plurality of computing entities adapted for invocation on a network entity in an interconnected network, each network entity adapted to launch and execute at least one network conversant app, the security manager further operable to:
identify a manner of execution of each of the computing entities, the manner of execution defining supporting resources employed in the execution; and
identify, based on the manner of execution, a security entity corresponding to each identified computing entity, the security entity operable to identify data associated with the computing entity;
the network entity responsive to the security manager to deploy the identified security entity, the security entity responsive to a security agent previously deployed on the network entity;
the network entity configured for enforcing a network policy by:
receiving, at a security manager in communication with each of the security entities, an indication of security entity operation;
evaluating the identified data upon ingress or egress to determine a security event; and
communicating with the security manager to provide consistent continued instantiation of the security entity.

10. The device of claim 9 wherein deploying the security entity further comprises:
installing the security agent via at least one of a pre-installed, read only flash and boot-strap key material for enabling secure communications with the security manager;
commencing the agent based on an instruction from the security manager, the agent having a trusted execution environment.

11. The device of claim 10 wherein the network entity further comprises an agent, the agent configured to
perform a secure handshake with the security manager;
determine if the security entity has been previously loaded; and
based on the determination, receive the transmitted the security entity at the network entity based on a public key exchange with the security manager.

12. The device of claim 11 wherein the agent is further operable to
copy the security entity to a temporary store on the network entity;
receive a public key portion of a public key pair from the security manager;
authenticate the copied security entity based on a public key corresponding to the received public key pair; and
upon successful authentication, copy the authenticated security entity to a persistent image area on the network entity for execution.

13. The device of claim 12 further wherein the public key portion obviates the need for transmission of a password credential for authenticating or decrypting the security entity.

14. The device of claim 12 wherein the agent is further configured to:
generate an index corresponding to an authenticated version of the security entity;
store the generated index pending successful authentication of the security entity;
move the security entity from an unauthenticated repository to an authenticated repository upon successful authentication; and
delete the generated index upon transferring an unencrypted version of the security entity to a launchable image area.

15. The method of claim 9 wherein the manner of execution includes hypervisors, containers and dedicated operating systems.

16. The method of claim 10 wherein the security entity is a container.

17. A computer program product on a non-transitory computer readable storage medium having instructions that, when executed by a processor, perform a method for enforcing network security, the method comprising:
identifying a plurality of computing entities adapted for invocation on a network entity in an interconnected network, each network entity adapted to launch and execute at least one network conversant app;
identifying a manner of execution of each of the computing entities, the manner of execution defining supporting resources employed in the execution;
identifying, based on the manner of execution, a security entity corresponding to each identified computing entity, the security entity operable to identify data associated with the computing entity;
deploying the identified security entity on a network entity, the security entity responsive to a security agent previously deployed on the network entity;
receiving, at a security manager in communication with each of the security entities, an indication of security entity operation; and
evaluating the identified data upon ingress or egress to determine a security event; and
communicating with the security manager to provide consistent continued instantiation of the security entity.
